(19) United States
(12) Patent Application Publication
(10) Pub. No.: US 2023/0065888 A1
(43) Pub. Date: Mar. 2, 2023

(54) PNEUMATIC TIRE

(71) Applicant: The Yokohama Rubber Co., LTD., Tokyo (JP)

(72) Inventor: Miyuki NAKAJIMA, Kanagawa (JP)

(21) Appl. No.: 17/759,316

(22) PCT Filed: Dec. 28, 2020
(86) PCT No.: PCT/JP2020/049080

§ 371 Date: Jul. 22, 2022

(30) Foreign Application Priority Data
Jan. 27, 2020 (JP) 2020-011174

(51) Int. Cl. B60C 9/00; B60C 9/22

(52) U.S. Cl. CPC B60C 9/0042; B60C 9/2204; B60C 2009/2038

(57) ABSTRACT

Provided is a pneumatic tire. A belt cover layer including organic fiber cords spirally wound along the tire circumferential direction is provided on the outer circumferential side of a belt layer in a tread portion. The belt cover layer includes at least one full cover layer covering the entire width direction of the belt layer, and the number of layers in the shoulder region is two or less. Polyethylene terephthalate fiber cords of which the elastic modulus at a load of 2.0 cN/dtex at 100° C. is in a range of 3.5 cN/(tex•%) to 5.5 cN/(tex•%) are used as the organic fiber cords constituting the belt cover layer. The ratio Sh/Ce of a rising amount Sh in the shoulder region and a rising amount Ce at a tire equator position during traveling at 240 km/h is 0.85 to 1.15.

### TECHNICAL FIELD

The present technology relates to a pneumatic tire using polyethylene terephthalate (PET) fiber cords in a belt cover layer.

### BACKGROUND ART

Pneumatic tires for a passenger vehicle or a light truck typically include a structure in which a carcass layer is mounted between a pair of bead portions, a plurality of belt layers are disposed on an outer circumferential side of the carcass layer in a tread portion, and a belt cover layer is disposed on an outer circumferential side of the belt layer, the belt cover layer including a plurality of organic fiber cords spirally wound along a tire circumferential direction. In this structure, the belt cover layer contributes to the improvement of high-speed durability and also contributes to the reduction of mid-range frequency road noise.

In the related art, nylon fiber cords are mainly applied to the organic fiber cords used in the belt cover layer; however, it has been proposed to use polyethylene terephthalate fiber cords (hereinafter referred to as PET fiber cords) that are highly elastic and inexpensive compared to nylon fiber cords (for example, see Japan Unexamined Patent Publication No. 2001-63312). However, a PET fiber cord unfortunately tends to generate heat more easily than the conventional nylon fiber cord. Thus, to reduce road noise by using a PET fiber cord, the PET fiber cord is required to reduce heat generation and improve durability under moist heat conditions.

### SUMMARY

The present technology provides a pneumatic tire capable of improving durability under moist heat conditions to reduce road noise by using PET fiber cords for a belt cover layer.

A pneumatic tire of the present technology includes: a tread portion extending in a tire circumferential direction and having an annular shape; a pair of sidewall portions respectively disposed on both sides of the tread portion; a pair of bead portions each disposed on an inner side of the sidewall portions in a tire radial direction; a carcass layer mounted between the pair of bead portions; a plurality of belt layers disposed on an outer circumferential side of the carcass layer in the tread portion; and a belt cover layer disposed on an outer circumferential side of the belt layers, the belt cover layer being formed by spirally winding an organic fiber cord coated with coating rubber along the tire circumferential direction, the organic fiber cord being a polyethylene terephthalate fiber cord of which an elastic modulus at a load of 2.0 cN/dtex at 100° C. is in a range of 3.5 cN/(tex•%) to 5.5 cN/(tex•%), the belt cover layer including at least one full cover layer covering an entire width direction of the belt layer, the number of layers of the belt cover layer in a shoulder region located on both sides in a tire width direction being 2 or less, and a ratio Sh/Ce of a rising amount Sh in the shoulder region and a rising amount Ce at a tire equator position during traveling at 240 km/h being 0.85 to 1.15.

As a result of diligent research on a pneumatic tire equipped with a belt cover layer including a PET fiber cord, the present inventor has achieved the present technology by finding that the fatigue resistance and the hoop effect of the cord suitable for the belt cover layer can be obtained by properly performing dip processing of a PET fiber cord and setting the elastic modulus under a load of 2.0 cN/dtex at 100° C. to be within a predetermined range. That is, in an embodiment of the present technology, a PET fiber cord of which the elastic modulus under the load of 2.0 cN/dtex at 100° C. is in the range of is 3.5 cN/(tex•%) to 5.5 cN/(tex•%) is used as the organic fiber cord constituting the belt cover layer. Thus, the road noise can be effectively reduced while satisfactorily maintaining durability of the pneumatic tire.

Further, as described above, the belt cover layer using this PET fiber cord has a structure in which the belt cover layer includes at least one full cover layer covering the entire width direction of the belt layer, and the number of layers of the belt cover layer in the shoulder region is two or less. Thus, it is possible to prevent the rigidity in the shoulder region from becoming excessively high while sufficiently suppressing the vibration of the belt layer in the entire width direction of the belt layer to reduce road noise, which makes it possible to prevent the occurrence of belt edge separation and ensure good tire durability.

In addition to this, due to the characteristics of the PET fiber cords and the structure of the belt cover layer described above, the ratio Sh/Ce of the rising amount Sh in the shoulder region and the rising amount Ce at the tire equator position during traveling at 240 km/h is set to 0.85 to 1.15. Thus, it is possible to prevent the tension of the belt cover layer in the shoulder region from becoming excessively high to prevent the occurrence of belt edge separation and ensure good tire durability while suppressing the vibration of the belt layer to ensure the good effect of reducing road noise.

In an embodiment of the present technology, an in-tire cord tension of the organic fiber cord is preferably 0.9 cN/dtex or more. This is advantageous in suppressing heat generation and improving the durability of the tire.

In the present technology, a region of 70% of the ground contact width centered on the tire equator of the tire is defined as a center region, and a region on the outer side of the center region in the tire width direction is defined as a shoulder region. At this time, the “ground contact width” is the distance between the ground contact edges on both sides in the tire width direction. “Ground contact edge” refers to end portions of a ground contact region in a tire axial direction. The ground contact region is formed when a regular load is applied to the tire mounted on a regular rim, inflated to a regular internal pressure, and placed vertically on a flat surface. “Regular rim” refers to a rim defined by a standard for each tire according to a system of standards that includes standards with which tires comply, and is “standard rim” defined by Japan Automobile Tyre Manufacturers Association (JATMA), “Design Rim” defined by The Tire and Rim Association, Inc. (TRA), or “Measuring Rim” defined by European Tire and Rim Technical Organization (ETRTO), for example. In the system of standards, including standards with which tires comply, “regular internal pressure” is air pressure defined by each of the standards for each tire and refers to “maximum air pressure” in the case of JATMA, the maximum value being listed in the table “TIRE LOAD LIMITS AT VARIOUS COLD INFLATION PRESSURES” in the case of TRA, or “INFLATION PRESSURE” in the case of ETRTO. However, “regular internal pressure” is 180 kPa in a case where a tire is for a passenger vehicle. “Regular load” is a load defined by a standard for each tire according to a system of standards that includes standards with which tires comply, and refers to a “maximum load capacity” in the case of JATMA, the maximum value being listed in the table of “TIRE LOAD LIMITS AT VARIOUS COLD INFLATION PRESSURES” in the case of TRA, or “LOAD CAPACITY” in the case of ETRTO. “Regular load” corresponds to 88% of the loads described above in a case where a tire is for a passenger vehicle.

### BRIEF DESCRIPTION OF DRAWINGS

FIG. 1 is a meridian cross-sectional view illustrating a pneumatic tire according to an embodiment of the present technology.

FIGS. 2A-2C are explanatory diagrams schematically illustrating a multilayer structure of a belt cover layer according to an embodiment of the present technology.

### DETAILED DESCRIPTION

Configurations according to embodiments of the present technology will be described in detail below with reference to the accompanying drawings.

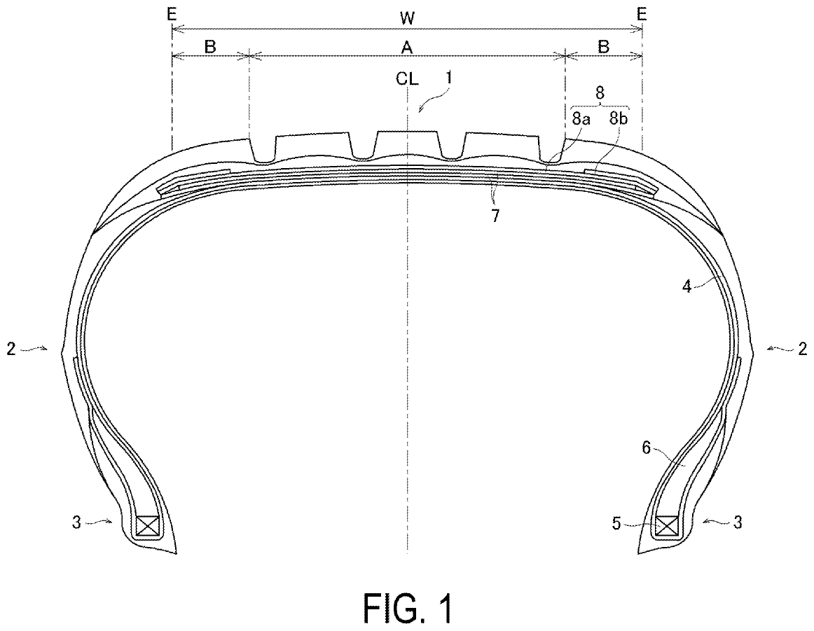

As illustrated in FIG. 1, a pneumatic tire of an embodiment of the present technology includes a tread portion 1, a pair of sidewall portions 2 disposed on both sides of the tread portion 1, and a pair of bead portions 3 disposed in the sidewall portions 2 on the inner side in the tire radial direction. In FIG. 1, reference numeral CL indicates a tire equator, reference numeral E indicates a ground contact edge, and reference numeral W indicates a ground contact width. Further, as shown in FIG. 1, a region of 70% of the ground contact width W centered on the tire equator CL is defined as a center region A, and the regions on the outer side in the tire width direction are defined as shoulder regions B. Although not illustrated in FIG. 1 because FIG. 1 is a meridian cross-sectional view, the tread portion 1, the sidewall portions 2, and the bead portions 3 each extend in a tire circumferential direction to form an annular shape. Thus, a toroidal basic structure of the pneumatic tire is configured. Although the description using FIG. 1 is basically based on the illustrated meridian cross-sectional shape, all of the tire components each extend in the tire circumferential direction and form the annular shape.

In the illustrated example, a plurality of main grooves (four main grooves in the illustrated example) extending in the tire circumferential direction are formed in the outer surface of the tread portion 1; however, the number of main grooves is not particularly limited. Further, in addition to the main grooves, various grooves and sipes that include lug grooves extending in a tire width direction can be formed.

A carcass layer 4 including a plurality of reinforcing cords extending in the tire radial direction are mounted between the pair of left and right bead portions 3. A bead core 5 is embedded within each of the bead portions, and a bead filler 6 having an approximately triangular cross-sectional shape is disposed on an outer periphery of the bead core 5. The carcass layer 4 is folded back around the bead core 5 from an inner side to an outer side in the tire width direction. Accordingly, the bead core 5 and the bead filler 6 are wrapped by a body portion (a portion extending from the tread portion 1 through each of the sidewall portions 2 to each of the bead portions 3) and a folded back portion (a portion folded back around the bead core 5 of each bead portion 3 to extend toward each sidewall portion 2) of the carcass layer 4. For example, polyester cords are preferably used as the reinforcing cords of the carcass layer 4.

A plurality (in the illustrated example, two layers) of belt layers 7 are embedded on an outer circumferential side of the carcass layer 4 in the tread portion 1. The belt layers 7 each include a plurality of reinforcing cords inclining with respect to the tire circumferential direction, and are disposed such that the reinforcing cords of the different layers intersect each other. In each belt layer 7, the inclination angle of the reinforcing cords with respect to the tire circumferential direction is set in a range of, for example, 10° to 40°. For example, steel cords are preferably used as the reinforcing cords of the belt layers 7.

A belt cover layer 8 is provided on an outer circumferential side of the belt layers 7 for the purpose of improving high-speed durability and reducing road noise. The belt cover layer 8 includes organic fiber cords oriented in the tire circumferential direction. In the belt cover layer 8, the angle of the organic fiber cords with respect to the tire circumferential direction is set, for example, to from 0° to 5°. The belt cover layer 8 is preferably configured such that a strip material made of at least a single organic fiber cord bunched and covered with coating rubber is wound spirally in the tire circumferential direction, and desirably has, in particular, a jointless structure.

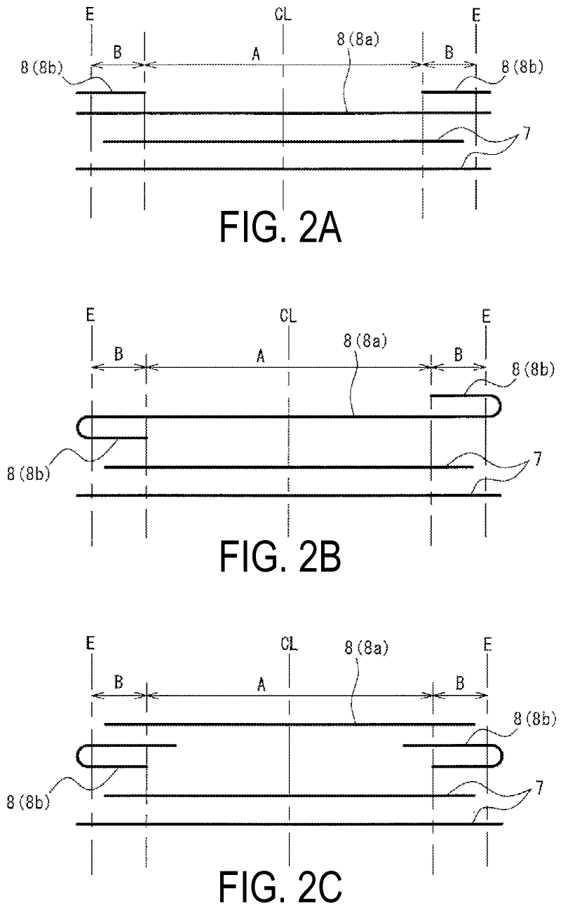

In an embodiment of the present technology, the belt cover layer 8 necessarily includes a full cover layer 8a that covers the entire region of the belt layers 7, and can be configured to include a pair of edge cover layers 8b that locally cover both end portions of the belt layers 7 as necessary (in the illustrated example, including both the full cover layer 8a and the edge cover layers 8b). However, when the edge cover layer 8b is included, the number of layers of the belt cover layer 8 in the shoulder region B is limited to two or less. In the case of the tire of FIG. 1 (see also FIG. 2A, which extracts and shows the belt layer 7 and the belt cover layer 8 of the tire of FIG. 1 in a simplified manner), one full cover layer 8a and a pair of edge cover layers 8b that are separately provided from this full cover layer 8a so as to cover the end portions of the belt layer 7 are provided. Therefore, the maximum number of layers of the belt cover layer 8 in the shoulder region is two, which is a structure corresponding to the present technology. Further, in the example of FIG. 2B, by continuously spirally winding the strip material in the tire circumferential direction, a structure in which one full cover layer 8a and the pair of edge cover layers 8b are continuous at the end portions on the outer side in the tire width direction is obtained. Also in this case, the maximum number of layers of the belt cover layer 8 in the shoulder region B is two, which corresponds to the present technology. On the contrary, in the example of FIG. 2C, one full cover layer 8a and a pair of edge cover layers 8b separately provided from the full cover layer 8a so as to cover the end portions of the belt layer 7 are provided. However, since each edge cover layer 8b is folded back to substantially form two layers, the shoulder region B includes a portion where the number of layers of the belt cover layer 8 is three. Therefore, the structure as shown in FIG. 2C does not correspond to the present technology. When two full cover layers 8a are provided, the number of layers of the belt cover layer 8 is two in both the center region A and the shoulder region B. However, since the number of layers in the shoulder region B is two or less, this structure corresponds to the present technology.

When the belt cover layer 8 is configured using the organic fiber cords having the physical properties described later by setting the multilayer structure of the belt cover layer 8 as described above, the rigidity can be suppressed from becoming excessively high in the shoulder region B while sufficiently suppressing the vibration of the belt layer 7 in the entire width direction of the belt layer 7 to reduce road noise. Thus, it is possible to prevent the occurrence of belt edge separation and ensure good tire durability. If the number of layers in the shoulder region B exceeds two as shown in FIG. 2C, the rigidity in the shoulder region B becomes excessively high, and belt edge separation may occur. Further, when the full cover layer 8a is not provided and only the edge cover layer 8b is provided (not illustrated), the vibration of the belt layer 7 cannot be suppressed in the entire width direction of the belt layer 7, and the effect of reducing road noise cannot be expected.

In an embodiment of the present technology, as the organic fiber cord constituting the belt cover layer 8, a polyethylene terephthalate fiber cord (PET fiber cord) in which the elastic modulus under a load of 2.0 cN/dtex at 100° C. is in the range of 3.5 cN/(tex•%) to 5.5 cN/(tex•%) is used. By using a specific PET fiber cord as the organic fiber cord constituting the belt cover layer 8 in this way, it is possible to effectively reduce road noise while satisfactorily maintaining durability of the pneumatic tire. When the elastic modulus of this PET fiber cord under a load of 2.0 cN/dtex at 100° C. is less than 3.5 cN/(tex•%), the mid-range frequency road noise cannot be sufficiently reduced. When the elastic modulus of the PET fiber cord under a load of 2.0 cN/dtex at 100° C. exceeds 5.5 cN/(tex•%), the fatigue resistance of the cord decreases and the durability of the tire decreases. In an embodiment of the present technology, the elastic modulus [N/(tex %)] under a load of 2.0 cN/dtex at 100° C. is calculated by conducting a tensile test under the conditions of a grip interval of 250 mm and a tensile speed of 300±20 mm/min in accordance with the “Test methods for chemical fibre tire cords” of JIS L1017, and converting the inclination of the tangent line at the point corresponding to the load 2.0 cN/dtex of the load-elongation curve into the value per tex.

When this organic fiber cord (PET fiber cord) is used as the belt cover layer 8, the in-tire cord tension may be preferably 0.9 cN/dtex or more, more preferably 1.5 cN/dtex to 2.0 cN/dtex. By setting the in-tire cord tension in this way, heat generation can be suppressed and tire durability can be improved. When the in-tire cord tension of this organic fiber cord (PET fiber cord) is less than 0.9 cN/dtex, the peak of tan δ rises, and the effect of improving the durability of the tire cannot be sufficiently obtained. The in-tire cord tension of the organic fiber cord (PET fiber cord) constituting the belt cover layer 8 is measured at two turns or more on the inner side in the tire width direction from the terminal of the strip material constituting the belt cover layer.

In the present technology, the rising amount of the tire is controlled by the above-mentioned characteristics of the PET fiber cords and the structure of the belt cover layer 8. Specifically, the ratio Sh/Ce of the rising amount Ce in the center region A and the rising amount Sh in the shoulder region B during traveling at 240 km/h is set to 0.85 to 1.15, preferably 0.95 to 1.00. The “rising amount” is the difference between the tire outer diameter in the reference state and the tire outer diameter in the traveling condition (during traveling at 240 km/h in the present technology) at the same location in the tire width direction. In the present technology, the value in the reference state is the tire outer diameter for traveling at a speed of 40 km/h under the condition of skim touch (load just before the tire touches the ground). Further, the rising amount Ce in the center region A is measured at the position of the tire equator CL. The rising amount Sh in the shoulder region B is measured at the location moved 1 mm toward the outer side in the tire width direction from the boundary position between the center region A and the shoulder region B (a position separated by 35% of the ground contact width W from the tire equator CL outward in the tire width direction). However, when the main groove exists in the shoulder region B, the rising amount is measured at the location moved 1 mm toward the outer side in the tire width direction from the outer edge portion of the main groove formed in the shoulder region B in the tire width direction.

In this way, the ratio Sh/Ce of the rising amount Ce in the center region A (the position of the tire equator CL) and the rising amount Sh in the shoulder region B during traveling at 240 km/h is set to 0.85 to 1.15. Thus, it is possible to prevent the tension of the belt cover layer in the shoulder region from becoming excessively high to prevent the occurrence of belt edge separation and ensure good tire durability while suppressing the vibration of the belt layer to ensure the good effect of reducing road noise. At this time, if the ratio Sh/Ce is less than 0.85, the vibration of the belt layer 7 cannot be suppressed, and the effect of reducing the road noise cannot be expected. If the ratio Sh/Ce exceeds 1.15, the tension of the belt cover layer 8 becomes excessively high in the shoulder region B, belt edge separation is likely to occur, and the tire durability may decrease.

In a case where polyethylene terephthalate fiber cords (PET fiber cords) are used as the organic fiber cords constituting the belt cover layer 8, the PET fiber cords preferably have a heat shrinkage stress of 0.6 cN/tex or more at 100° C. The heat shrinkage stress at 100° C. is set in this way, and thus road noise can be effectively reduced while durability of the pneumatic tire is maintained more effectively and successfully. When the heat shrinkage stress of the PET fiber cords at 100° C. is less than 0.6 cN/tex, the hoop effect during traveling cannot be sufficiently improved, and it is difficult to sufficiently maintain high-speed durability. The upper limit value of the heat shrinkage stress of the PET fiber cords at 100° C. is not particularly limited, but is preferably, for example, 2.0 cN/tex. Note that in an embodiment of the present technology, the heat shrinkage stress (cN/tex) at 100° C. is heat shrinkage stress of a sample cord, which is measured with reference to “Test methods for chemical fiber tire cords” of JIS-L1017 and when heated under the conditions of the sample length of 500 mm and the heating condition at 100° C. for 5 minutes.

In order to obtain the PET fiber cords having the aforementioned physical properties, for example, it is preferable to properly perform dip processing. In other words, before a calendar process, dip processing with adhesive is performed on the PET fiber cords; however, in a normalizing process after a two-bath treatment, it is preferable that an ambient temperature is set within the range of 210° C. to 250° C. and cord tension is set in the range of 2.2×10⁻² N/tex to 6.7×10⁻² N/tex. Accordingly, desired physical properties as described above can be imparted to the PET fiber cords. When the cord tension in the normalizing process is smaller than 2.2×10⁻² N/tex, cord elastic modulus is low, and thus the mid-range frequency road noise cannot be sufficiently reduced. In contrast, when the cord tension is greater than 6.7×10⁻² N/tex, cord elastic modulus is high, and thus fatigue resistance of the cords is low.

An embodiment of the present technology will further be described below by way of Examples, but the scope of an embodiment of the present technology is not limited to Examples.

### EXAMPLES

The tires of Conventional Example 1, Comparative Examples 1 to 7, and Examples 1 to 6 were manufactured, and the tires had a tire size of 225/60R18 and had the basic structure illustrated in FIG. 1, and the elastic modulus of the organic fiber cords (PET fiber cords) constituting the belt cover layer at 100° C. under a load of 2.0 cN/dtex [cN/(tex•%)], the in-tire cord tension [cN/dtex], the belt cover layer structure, and the ratio Sh/Ce of the rising amount Sh in the shoulder region and the rising amount Ce in the center region during traveling at 240 km/h were changed as shown in Tables 1 and 2.

In these examples, the belt cover layer has a jointless structure in which a strip formed by bunching one organic fiber cord (PET fiber cord) and covering it with coating rubber is spirally wound in the tire circumferential direction. The cord density in the strip is 50 cords/50 mm. Further, each organic fiber cord (PET fiber cord) has a structure of 1100 dtex/2.

In each example, the elastic modulus [cN/(tex•%)] under a load of 2.0 cN/dtex at 100° C. was calculated by conducting a tensile test under the conditions of a grip interval of 250 mm and a tensile speed of 300±20 mm/min in accordance with the “Test methods for chemical fibre tire cords” of JIS-L1017, and converting the inclination of the tangent line at the point corresponding to the load 2.0 cN/dtex of the load-elongation curve into the value per tex. Further, the in-tire cord tension [cN/dtex] was obtained by removing the tread rubber from the tread portion 1 to expose the belt cover layer, peeling the fiber cord from a predetermined length range of the belt cover layer, measuring the length of the peeled fiber cord after collection thereof, and obtaining the amount of contraction with respect to the length before collection. Particularly, the average amount of contraction was obtained from five fiber cords located at the center of the belt layer on the outermost side. Then, the load corresponding to the amount of contraction (%) was obtained from the S-S curve and measured by converting it into the value per dtex. The tension Ce was measured on five fiber cords located in the center portion of the outermost belt layer 7, and the tension Sh was measured on five fiber cords located on the shoulder portion of the outer belt layer 7.

For each example, the rising amounts Ce and Sh were calculated as follows. Each test tire was assembled on a wheel with a rim size of 18×7J, oxygen was sealed at an internal pressure of 230 kPa, and the tire was mounted on a drum tester equipped with a drum made of steel with a smooth surface and a diameter of 1707 mm. The ambient temperature was controlled to 38±3° C., the tire outer diameter in the reference state (speed 40 km/h and skim touch condition (load just before the tire touches the ground)) and the tire outer diameter in the traveling condition (speed 240 km/h, load 5.67 kN) were measured, and the difference (value obtained by subtracting the value in the reference state from the value in the traveling condition) was calculated as the rising amount. The rising amount Ce in the center region was measured at the position of the tire equator CL. The rising amount Sh in the shoulder region B was measured at the location moved 1 mm outward in the tire width direction from the boundary position between the center region A and the shoulder region B (since the tire has the basic structure of FIG. 1, the boundary position coincides with the outer edge in the tire width direction of the outermost main groove in the tire width direction).

The column of “Belt cover layer structure” in Table 1 indicates the number of the corresponding diagram. Comparative Example 6 has a structure having only an edge cover layer and no full cover layer (a structure in which the full cover layer is removed from FIG. 2A).

These test tires were evaluated for road noise, moist heat durability, and the presence of belt cover separation by the following evaluation methods, and the results are also shown in Tables 1 and 2.

### Road Noise

Each of the test tires was mounted on a wheel having a rim size of 18×7J, mounted as front and rear wheels of a passenger vehicle (front wheel drive vehicle) having an engine displacement of 2.5 L, and inflated to an air pressure of 230 kPa, and a sound collecting microphone was placed on an inner side of the window of the driver's seat. A sound pressure level at or near the frequency 315 Hz was measured when the vehicle was driven at an average speed of 50 km/h on a test course having an asphalt road surface. The evaluation results were based on Conventional Example 1 as a reference and indicated the amount of change (dB) to the reference.

### Moist Heat Durability

Each of the test tires was mounted on a wheel having a rim size of 18×7J, inflated with oxygen to an internal pressure of 230 kPa, and held for 30 days in a chamber maintained at a chamber temperature of 70° C. and a humidity of 95%. The pre-treated test tires in this way were mounted on a drum tester with a drum having a smooth steel surface and a diameter of 1707 mm, and the ambient temperature was controlled to 38±3° C. The speed was increased from 120 km/h in increments of 50 km/h in 24 hours, and the traveling distance until failure occurred in the tire was measured. The evaluation results are expressed as index values using measurement values of the traveling distance, with Conventional Example 1 being assigned an index value of 100. Larger index values indicate longer traveling distance until failure occurs, and better moist heat durability.

### Presence of Belt Edge Separation

After performing the above-mentioned moist heat durability test, each test tire was disassembled and the presence of separation (belt edge separation) in the belt cover layer was visually confirmed. The evaluation results are indicated by “Yes” when the belt edge separation occurred and “No” when the belt edge separation did not occur.

TABLE 1-1

| | | Conven- | Compar- | Compar- | Compar- |
|---|---|---|---|---|---|
| | | tional | ative | ative | ative |
| | | Example | Example | Example | Example |
| | | 1 | 1 | 2 | 3 |
| Elastic | cN/ | 2.0 | 6.0 | 5.8 | 3.2 |
| modulus | (tex · %) | | | | |
| In-tire cord | cN/ | 0.7 | 0.7 | 0.7 | 0.7 |
| tension | dtex | | | | |
| Belt cover | | FIG. 2B | FIG. 2B | FIG. 2B | FIG. 2B |
| layer | | | | | |
| structure | | | | | |
| Ratio Sh/Ce | | 0.80 | 0.80 | 0.80 | 0.90 |
| Road noise | dB | 0 | −3.0 | −2.8 | −0.5 |
| performance | | | | | |
| Moist heat | index | 100 | 81 | 85 | 90 |
| durability | value | | | | |
| Presence of | | No | Yes | Yes | Yes |
| belt edge | | | | | |
| separation | | | | | |

TABLE 1-2

| | | Comparative | Comparative | Comparative |
|---|---|---|---|---|
| | | Example 4 | Example 5 | Example 6 |
| Elastic | cN/ | 4.5 | 4.5 | 4.5 |
| modulus | (tex · %) | | | |
| In-tire cord | cN/ | 0.7 | 0.7 | 0.7 |
| tension | dtex | | | |
| Belt cover layer | | FIG. 2B | FIG. 2B | Without full |
| structure | | | | cover |
| Ratio Sh/Ce | | 0.80 | 1.20 | 0.70 |
| Road noise | dB | −0.2 | −1.8 | −1.8 |
| performance | | | | |
| Moist heat | index | 95 | 87 | 87 |
| durability | value | | | |
| Presence of | | Yes | Yes | No |
| belt edge | | | | |
| separation | | | | |

TABLE 2-1

| | | Comparative | | |
|---|---|---|---|---|
| | | Example 7 | Example 1 | Example 2 |
| Elastic | cN/ | 4.5 | 3.8 | 5.3 |
| modulus | (tex · %) | | | |
| In-tire | cN/ | 0.7 | 0.7 | 0.7 |
| cord tension | dtex | | | |
| Belt cover layer | | FIG. 2C | FIG. 2B | FIG. 2B |
| structure | | | | |
| Ratio Sh/Ce | | 0.83 | 0.87 | 0.98 |
| Road noise | dB | −1.8 | −1.5 | −2.8 |
| performance | | | | |
| Moist heat | index | 87 | 105 | 110 |
| durability | value | | | |
| Presence of | | Yes | No | No |
| belt edge | | | | |
| separation | | | | |

TABLE 2-2

| | | Example | Example | Example | Example |
|---|---|---|---|---|---|
| | | 3 | 4 | 5 | 6 |
| Elastic | cN/ | 5.0 | 4.5 | 4.5 | 4.5 |
| modulus | (tex · %) | | | | |
| In-tire | cN/ | 0.7 | 1.8 | 0.9 | 0.9 |
| cord tension | dtex | | | | |
| Belt cover | | FIG. 2B | FIG. 2B | FIG. 2B | FIG. 2B |
| layer | | | | | |
| structure | | | | | |
| Ratio Sh/Ce | | 0.95 | 0.96 | 0.99 | 1.15 |
| Road noise | dB | −2.5 | −2.0 | −2.9 | −3.0 |
| performance | | | | | |
| Moist heat | index | 112 | 123 | 120 | 122 |
| durability | value | | | | |
| Presence of | | No | No | No | No |
| belt edge | | | | | |
| separation | | | | | |

As can be seen from Tables 1 and 2, the tires of Examples 1 to 6 had reduced road noise and improved moist heat durability in comparison with Conventional Example 1 as a reference. On the other hand, in the tires of Comparative Examples 1 and 2, since the elastic modulus of the polyethylene terephthalate fiber cords constituting the belt cover layer was high at a load of 2.0 cN/dtex at 100° C., the moist heat durability degraded, and belt edge separation occurred. In the tire of Comparative Example 3, since the elastic modulus of the polyethylene terephthalate fiber cords constituting the belt cover layer was low at a load of 2.0 cN/dtex at 100° C., the road noise could not be sufficiently reduced, moist heat durability degraded, and belt edge separation occurred. In Comparative Example 4, since the ratio Sh/Ce was small, the road noise could not be sufficiently reduced, the moist heat durability degraded, and the belt edge separation occurred. In Comparative Example 5, since the ratio Sh/Ce was large, the moist heat durability degraded and belt edge separation occurred. In Comparative Example 6, since the full cover layer was not provided, the road noise could not be sufficiently reduced, and the moist heat durability degraded. In Comparative Example 7, since the number of layers of the belt cover layer in the shoulder region exceeded two, the moist heat durability degraded and belt edge separation occurred.

1. A pneumatic tire comprising:
a tread portion extending in a tire circumferential direction and having an annular shape;
a pair of sidewall portions respectively disposed on both sides of the tread portion;
a pair of bead portions each disposed on an inner side of the sidewall portions in a tire radial direction;
a carcass layer mounted between the pair of bead portions;
a plurality of belt layers disposed on an outer circumferential side of the carcass layer in the tread portion; and
a belt cover layer disposed on an outer circumferential side of the belt layers,
the belt cover layer being formed by spirally winding an organic fiber cord covered with coating rubber, along the tire circumferential direction, the organic fiber cord being a polyethylene terephthalate fiber cord of which an elastic modulus at a load of 2.0 cN/dtex at 100° C. is in a range of 3.5 cN/(tex•%) to 5.5 cN/(tex•%),
the belt cover layer including at least one full cover layer covering an entire width direction of the belt layer, a number of layers of the belt cover layer in a shoulder region located on both sides in a tire width direction being 2 or less, and
a ratio Sh/Ce of a rising amount Sh in the shoulder region and a rising amount Ce at a tire equator position during traveling at 240 km/h being 0.85 to 1.15.

2. The pneumatic tire according to claim 1, wherein an in-tire cord tension of the organic fiber cord is 0.9 cN/dtex or more.
